(19) United States
(12) Patent Application Publication
(10) Pub. No.: US 2009/0146514 A1
(43) Pub. Date: Jun. 11, 2009

(54) Vibration generator for a vibration pile driver

(75) Inventors: Christian Heichel, Niedernberg (DE); Albrecht Kleibl, Grosshennersdorf (DE)

Correspondence Address: DEVINE, MILLIMET & BRANCH, 111 AMHERST STREET, P.O. BOX 719, MANCHESTER, NH, 03105, US

(73) Assignee: ABI Anlagentechnik-Baumaschinen-Industriebedarf Maschinenfabrik und Vertriebsgesellschaft mbH

(21) Appl. No.: 12/315,718

(22) Filed: Dec. 5, 2008

(30) Foreign Application Priority Data
Dec. 6, 2007 (EP) EP 07025254.9

(51) Int. Cl. H02K 7/06

(52) U.S. Cl. 310/81

(57) ABSTRACT

A vibration generator has rotatable imbalance masses disposed on at least two shafts, in which means for adjusting the rotational position of the imbalance masses relative to one another are disposed. There is at least one sensor for determining the angular acceleration of the rotating imbalance masses. The sensors may also determine acceleration of the vibration generator. There is a module for determining the angular acceleration of the rotating imbalance masses on the basis of the measurement values determined by the sensors. A vibration pile driver for introducing elements to be pile-driven into the ground, and drawing them from the ground, as well as for compacting ground material, contains one of the aforementioned vibration generators.

### CROSS REFERENCE TO RELATED APPLICATIONS

Applicants claim priority under 35 U.S.C. 119 of European Application No. 07025.254.9 filed Dec. 6, 2007.

### BACKGROUND OF THE INVENTION

1. Field of the Invention

The invention relates to a vibration generator for a vibration pile driver, and a vibration pile driver.

2. The Prior Art

In construction, vibration generators are used to introduce objects, such as profiles, into the ground, or to draw them from the ground, or also to compact ground material. The ground is excited by vibration, and thereby achieves a “pseudo-fluid” state. The goods to be driven in can then be pressed into the construction ground by a static top load. The vibration is characterized by a linear movement and is generated by rotating imbalances that run in opposite directions, in pairs, within a vibrator gear mechanism. Vibration generators are characterized by the rotating imbalance and by the maximal speed of rotation.

Vibration generators are vibration exciters having a linear effect, whose centrifugal force is generated by rotating imbalances. These vibration exciters move at a changeable speed. The size of the imbalance is also referred to as “static moment.” The progression of the speed of the linear vibration exciter corresponds to a periodically recurring function, for example a sine function, but it can also assume other shapes. If the center of gravity of the imbalance lies in the movement direction or perpendicular to it, the angular acceleration of the imbalance and all of the rotating parts connected with it is 0. Maximal values of the angular acceleration occur if the imbalances are deflected by approximately 45, 135, 225, or 315 degrees relative to the movement direction.

Due to the changing vibration speed, a change in the kinetic energy of the housing of the vibration generator is brought about, which is transferred as a reactive power and periodically absorbed, stored, and given off again by the parts that rotate within the vibration generator, particularly shafts, imbalances, and gear wheels. This energy, brought about by changing angular accelerations, brings about increased stress on machine elements, such as bearings or couplings. This set of problems is further intensified by power-increasing measures of the vibration generator, such as light construction, increase in static moment (imbalance), or increase in the speed of rotation.

### SUMMARY OF THE INVENTION

This is where the invention provides a remedy. It is an object of the invention to create a vibration exciter that allows a reduction in the stresses of machine elements indicated by changing vibration speeds during operation.

With the invention, a vibration exciter is created that allows a reduction in the stresses of machine elements indicated by changing vibration speeds during operation. By providing at least two sensors for detecting the angular acceleration of the rotating imbalance masses, a change in the angular acceleration can be determined directly, therefore making it possible to subsequently regulate the operating state of the vibration generator.

Alternatively, sensors for detecting the relative position of the imbalance masses relative to one another, as well as for detecting the acceleration of the vibration generator, can be provided. Using the measurement values determined in this way, a corresponding determination of the angular acceleration of each of the rotating imbalance masses that is being applied is made possible, with the aid of the known mass inertia of the vibration generator.

Preferably, the sensors comprise inductive sensors and/or rotary position transducers. Such sensors have proven to be long-lasting and robust.

In a further development of the invention, the sensors are connected with an evaluation unit that compares the measurement values determined by the sensors with stored maximal values. In this way, detection of load peaks is made possible. Preferably, the evaluation unit determines the static moment that is applied on the basis of the measurement values determined by the sensors.

In an embodiment of the invention, the evaluation unit is connected with an acoustical and/or visual warning device. In this way, it is possible to inform the operator about a critical state, in an acoustical or visual manner. Preferably, a device for regulating the vibration generator is provided, which is connected with the evaluation unit. In this way, automatic regulation of the vibration generator as a function of the measurement values of the vibration generator that are determined is made possible.

In an embodiment of the invention, the means for changing the rotational position of the imbalance masses relative to one another can be controlled by way of the regulation device. In this way, direct regulation of the static moment of the vibration generator is made possible.

It is advantageous if the evaluation unit has a memory-programmable control (programmable logic controller PLC). In this way, flexible control of the vibration generator is made possible.

It is also an object of the invention to provide a vibration pile driver that allows a reduction in the stresses of machine elements indicated by changing vibration speeds during operation. According to the invention, this task is accomplished by a vibration pile driver that allows a reduction in the stresses of machine elements indicated by changing vibration speeds during operation.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a schematic representation of a vibration pile driver with a support device according to one embodiment of the invention; and

FIG. 2 shows a schematic representation of a vibrator gear mechanism in longitudinal section.

### DETAILED DESCRIPTION OF THE PREFERRED EMBODIMENT

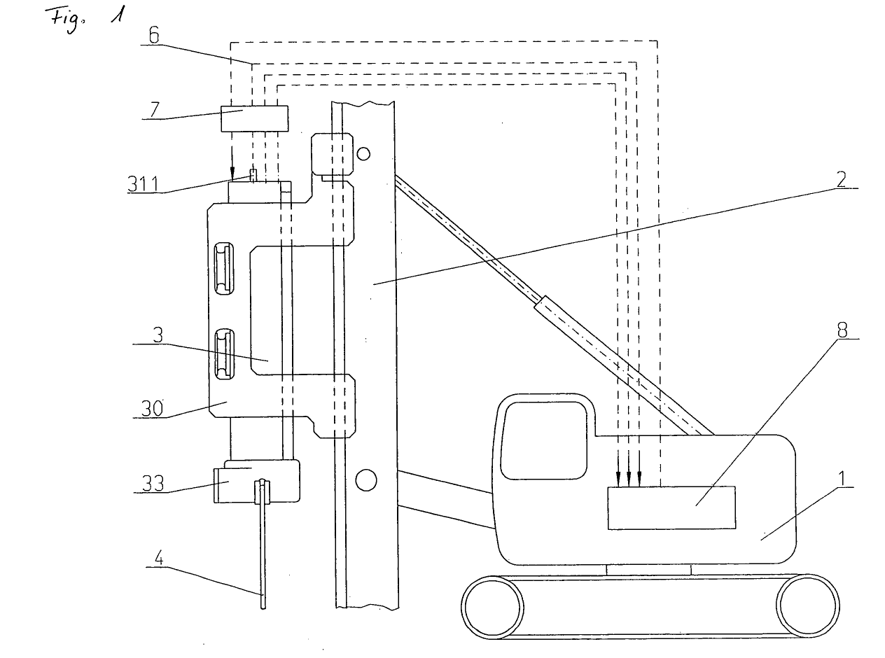

Referring now in detail to the drawings, the vibration pile driver shown in FIG. 1 consists essentially of a support device 1, on which a vibration generator (vibrator) 3 is disposed so that it can be displaced vertically, by way of a mast 2. Vibration generator 3 comprises a housing 31, which is surrounded by a hood 30. Clamping pliers 37 for accommodating pile-driven material 4 are disposed on hood 30. Hood 30 serves to guide vibration generator 3, and transfers the static force of mast 2 to vibration generator 3. Vibration generator 3 generates a vibration, by way of rotating imbalances 3311, 3321, 3331, 3511, 3521, 3531, which vibration is transferred to material 4 to be pile-driven, by way of clamping pliers 37.

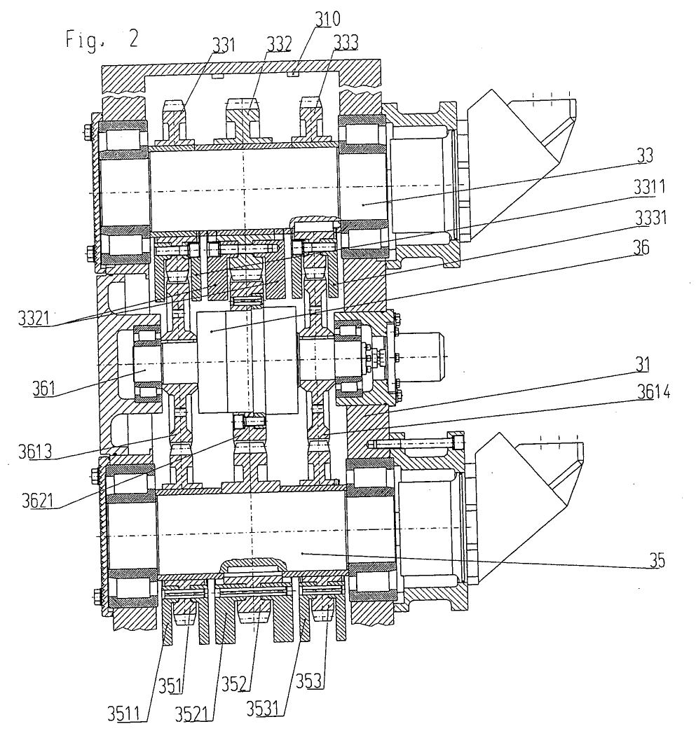

Vibration generator 3 is structured as a vibrator gear mechanism (FIG. 2). It consists essentially of a housing 31, in which two shafts 33, 35 provided with gear wheels 331, 332, 333, 351, 352, 353 are mounted to rotate. Gear wheels 331, 332, 333, 351, 352, 353 are each provided with imbalance masses 3311, 3321, 3331, 3511, 3521, 3531, and the gear wheels of the two shafts 33, are in engagement with one another by way of gear wheels 3613, 3614 of rotor shaft 361 of a pivot motor 36. Gear wheels 331, 332, 333, 351, 352, 353 provided with imbalance masses 3311, 3321, 3331, 3511, 3521, 3531 are adjustable in their rotational position, relative to one another, by way of pivot motor 36, thereby making it possible to adjust the resulting imbalance, i.e. the resulting static moment. Such vibrator gear mechanisms with imbalance masses mounted so as to rotate, which are adjustable in their relative phase position, are known to a person skilled in the art, for example from German Patent Application No. DE 20 2007 005 283 U1.

Vibration generator 3 is provided with two inductive sensors 310, disposed on the inside of housing 31, parallel to the circumference of the gear wheels, at a distance from one another, lying opposite gear wheels 331, 332, 333, 351, 352, 353, in each instance. Inductive sensors 310 allow detection of the angular acceleration of rotating imbalance masses 3311, 3321, 3331, 3511, 3521, 3531. Furthermore, by way of the time offset of the imbalance masses 3311, 3321, 3331, 3511, 3521, 3531, their position relative to one another can be determined. Furthermore, an acceleration sensor 311 is disposed on housing 31 of vibration generator 3. A memory-programmable control (programmable logic controller PLC) 7 is disposed as an evaluation unit for processing the signals of sensors 310, 311, and determining the aforementioned variables, which control furthermore calculates the static moment that is applied on the basis of the frequency and time offset of the imbalance masses relative to one another.

A control 8 is disposed in support device 1, and connected with the PLC 7 by way of lines 6. Control 8 is set up in such a manner that it calculates a permissible angular acceleration of the rotating parts of vibration exciter 3 from the static moment determined by the PLC 7 and the acceleration data determined by sensor 311.

If the permissible acceleration is exceeded, control of pivot motor 36 within vibration generator 3 takes-place by way of a regulation device—not shown—thereby bringing about re-setting of the resulting imbalance/the resulting static moment by means of a change in the position of the imbalance masses relative to one another.

In an alternative embodiment of the vibration generator, a determination of the rotational position of the imbalance masses 3311, 3321, 3331, 3511, 3521, 3531 relative to one another is possible, by way of one or more rotary position transducers. In this embodiment, a calculation of the angular acceleration applied to the rotating imbalance masses 3311, 3321, 3331, 3511, 3521, 3531, takes place by way of PLC 7, on the basis of the previously known mass inertia of the vibration generator, by means of the values determined by the rotary position transducers and acceleration sensor 311.

In addition, the installation of an optical and/or acoustical signal in the operator's cabin of the support device is possible, in order to inform the operator of the fact that permissible acceleration values have been exceeded. In this case, the resulting imbalance/the resulting static moment can be re-set by the operator, by means of corresponding control of the pivot motor within vibration generator 3.

Accordingly, while only a few embodiments of the present invention have been shown and described, it is obvious that many changes and modifications may be made thereunto without departing from the spirit and scope of the invention.

What is claimed is:

1. A vibration generator comprising:
rotatable imbalance masses disposed on at least two shafts;
means for adjusting a rotational position of the imbalance masses relative to one another; and
at least one sensor for determining angular acceleration of the imbalance masses during rotation.

2. The vibration generator according to claim 1, wherein the sensors comprise inductive sensors or rotary position transducers.

3. The vibration generator according to claim 1, wherein the sensors are connected with a module that compares values determined by the sensors with maximal values stored in memory.

4. The vibration generator according to claim 3, wherein the module determines a static moment being applied on the basis of each of the values determined by the sensors.

5. The vibration generator according to claim 3, wherein the module is connected with an acoustical or visual warning device.

6. The vibration generator according to claim 3, further comprising a device for regulating the vibration generator, said device being connected with the module.

7. The vibration generator according to claim 6, wherein the means for changing the rotational position of the rotating imbalance masses relative to one another are controlled by way of the device for regulating the vibration generator.

8. The vibration generator according to claim 3, wherein the module has a memory-programmable control (programmable logic controller PLC).

9. A vibration pile driver for introducing elements to be pile-driven into the ground, and drawing them from the ground, as well as for compacting ground material, comprising a vibration generator according to claim 1.

10. A vibration generator comprising:
rotatable imbalance masses disposed on at least two shafts;
means for adjusting the rotational position of the imbalance masses relative to one another;
sensors for determining the position of the imbalance masses relative to one another and acceleration of the vibration generator; and
a module for determining angular acceleration of the imbalance masses during rotation on the basis of measurement values determined by the sensors.

11. The vibration generator according to claim 10, wherein the sensors comprise inductive sensors or rotary position transducers.

12. The vibration generator according to claim 10, wherein the module compares values determined by the sensors with maximal values stored in memory.

13. The vibration generator according to claim 12, wherein the module determines a static moment being applied on the basis of each of the values determined by the sensors.

14. The vibration generator according to claim 12, wherein the module is connected with an acoustical or visual warning device.

15. The vibration generator according to claim 12, further comprising a device for regulating the vibration generator, said device being connected with the module.

16. The vibration generator according to claim 15, wherein the means for changing the rotational position of the rotating imbalance masses relative to one another are controlled by way of the device for regulating the vibration generator.

17. The vibration generator according to claim 12, wherein the module has a memory-programmable control (programmable logic controller PLC).

18. A vibration pile driver for introducing elements to be pile-driven into the ground, and drawing them from the ground, as well as for compacting ground material, comprising a vibration generator according to claim 2.
